(19) United States
(12) Patent Application Publication
(10) Pub. No.: US 2008/0136973 A1
(43) Pub. Date: Jun. 12, 2008

(54) Portable projector system

(76) Inventor: Ellis Park, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 11/635,985

(22) Filed: Dec. 8, 2006

(51) Int. Cl. H04N 9/31

(52) U.S. Cl. 348/744; 348/E09.025

(57) ABSTRACT

A projector system is adapted for use with a portable computer and comprises a projector assembly configured to be detachably connectable to the portable computer. The projector assembly includes a projector lamp for projecting images onto a surface and is wirelessly connectable with a remote server such as via satellite communications to access content from the remote server. The projector assembly further includes a swivelable mount configured to provide free rotation of the projector lamp such that the lamp can be reoriented into any desired orientation. The projector system may further comprise a video camera or still camera in electronic communication with the portable computer in order to capture images for digitization and transmission to the remote server or for display on the display monitor of the portable computer or for projection by the projector lamp.

### CROSS-REFERENCE TO RELATED APPLICATIONS

### (Not Applicable)

### STATEMENT RE: FEDERALLY SPONSORED RESEARCH/DEVELOPMENT

### (Not Applicable)

### BACKGROUND

The present invention relates generally to presentation systems and, more particularly, to a uniquely configured projector system adapted for use with a portable computer and which includes a projector assembly configured to be swivelably mountable to the portable computer and allowing wireless communications with a remote server for transmission of images by the projector assembly onto any surface. The projector system further includes a uniquely configured video camera and still camera which may be combinable with the projector assembly and which may be swivelably mounted to the portable computer. The video camera and still camera allow for capturing of images which may be wirelessly transmitted to the remote server or projected by the projector assembly. In addition, the projector system is adapted to receive images from the remote server such as via the portable computer for projection by the projector assembly in remote locations.

Commonly used in presenting information to audiences, projectors of the prior art are typically connected to portable computers such as a personal computer (PC) or a laptop computer. The portable computer is conventionally used to regulate the progress of the presentation in displaying images. Such images may be stored in the PC or alternatively may be contained in a data file such as on a diskette, a CD-ROM, a flash memory stick or other suitable storage device.

In making presentations at remote locations, the presenter must typically carry their laptop computer as well as the projector unit to the remote location. The projector unit and laptop are then connected to one another prior to beginning the presentation. The presentation can take many forms such as the popular PowerPoint™ presentation program but may also include the presentation of images such as still images or video files (i.e., movies) using other presentation programs. Presentations can additionally include audio such as narration and/or music accompanying the presentation.

For business people and educators in urban settings, such presentations are typically held in institutional or business environments wherein modern infrastructure is typically integrated into the building wherein the presentation will be held. For example, many modern buildings are pre-wired with cable connectivity to a local area network (LAN) or wider networks such as the internet network. In addition, wireless capability is increasingly built into many new buildings to allow wireless communication of electronic devices within areas of the building that are covered by the wireless network.

Furthermore, many buildings include wireless access to the internet by portable electronic devices such as laptop computers. Even further, power for operating various electronic devices such as portable computers and projectors of the type widely used for giving presentation is readily available through wall outlets in almost every building or structure in most developed countries.

However, in undeveloped countries of the third world, the availability of power and infrastructure for connecting electronic devices is not nearly so prevalent. Even further, for those countries wherein at least some of the buildings are wired for power, the actual availability of power to the building is largely unreliable. Therefore, the ability to give presentations in third world countries using a laptop and a portable projector presents additional challenges. However, the ability to reach out and educate the inhabitants of such third world countries is critical in promoting health in general and preventing disease in particular.

In addition, missionaries in undeveloped countries may require the ability to present materials to inhabitants of such third world countries for various socio-economic purposes such as for improving trade and economic development, increasing the literacy rate, raising political consciousness and promoting infrastructure improvements by presenting information regarding the construction of roads, buildings and bridges in an effort to improve the human condition in such countries. As is well known, missionaries may also include spiritual and religious teachings in their presentations by promoting the study of scripture and espousing the observance of moral and ethical values as a way of improving the quality of life.

Considering the difficulties in making presentations with a laptop and a projector in an urban environment, such difficulties are magnified considering the need for shipping such equipment overseas and then carrying such equipment to remote locations. The difficulty in making presentations in third world countries is exacerbated by the fact that many third work countries lack the availability of reliable power that is typically necessary to operate such electronic devices.

In addition, presentations in such remote locations are further complicated due to the unavailability of any hardwire or wireless connection to a source from which images can be accessed. For example, in most remote locations, access to the internet is typically unavailable by conventional wire (e.g., cable) connection. Therefore, access to the internet for downloading images or content to be presented is typically only available by wireless means such as via satellite communications.

As can be seen, there exists a need in the art for a system by which presentations may be given in remote locations with a minimal amount of equipment and wherein such equipment is easily carried and is preferably of a small size. In addition, there exists a need in the art for a system for presenting materials in remote locations wherein the content to be presented is wirelessly accessible from a remote server in order to obviate the need for carrying additional memory devices upon which materials are typically stored.

Furthermore, there exists a need in the art for a system for presenting various materials in remote locations wherein the system includes the capability to capture images at the remote location for manipulation thereof and/or transmission back to a server for later broadcast by news agencies and/or for access by other users in other remote locations. It is further desirable that such projector system eliminates the need for a separate presentation screen to further minimize the equipment that must be carried to the location of the presentation.

### BRIEF SUMMARY

These and other deficiencies associated with projector systems of the prior art are addressed and alleviated by the present invention which includes a projector system which is adapted for use with a portable computer and which comprises a projector assembly that may be detachably coupled to the portable computer such as at a data port of the portable computer. The projector assembly includes at least one projector lamp which may be included with a video and/or still camera and which is preferably swivelably mountable to the portable computer or is integrated therewith and is adapted for projecting images onto a surface such as a presentation screen in an office building or onto the side of a building such as a home in an undeveloped country.

The projector assembly is specifically adapted to wirelessly communicate with a remote server for accessing images which may be contained on the remote server for subsequent projection by the projector lamp at the remote location. The portable computer may include a monitor portion which may be pivotally attached to a keyboard portion as is common for many modern laptop computer configurations. The projector lamp may be integrated into the portable computer or may be configured to be removably mountable to the keyboard portion and/or monitor portion. The projector lamp may be powered by the portable computer and/or by a separate power source integrated into the projector assembly. The projector lamp may further by combinable with the video and/or still camera.

The projector assembly may further include a swivel mount which is configured to allow for free rotation of the projector lamp in a wide field of view in order to allow reorientation of the projector lamp for display of images by audience members from any viewing angle. The projector assembly may be further configured to display images in static and/or dynamic three-dimensional (3D) holographic form. For example, it is contemplated that a dynamic likeness of a speaker delivering a historical speech may be dynamically recreated in 3D holographic form to enhance the impact of the speech upon a listening audience.

The projector assembly is adapted to allow for real-time communication with the remote server for transmission and receipt of images to and from the remote server. It is contemplated that the projector assembly and/or portable computer are in communication with the remote server through an internet network as facilitated by satellite communication technology or cellular telephone technology. The portable computer and/or the projector assembly may be adapted to transmit and receive data to the remote server such as via a portable satellite dish which itself may be in wireless or hardwire communication with the portable computer and/or projector assembly.

The projector system may further include at least one of a video camera and a still camera which may be swivelably mounted to the portable computer and in electronic communication therewith via any suitable wireless or hardwired means. At least one of the video camera and still camera may be integrated with the projector assembly but may optionally be separately rotatable and/or swivelable such as by mounting on opposing sides of the portable computer. Such separate mounting may prevent interference between the high-intensity projection and the contemporaneous capturing of moving and/or still images by the video and still cameras. The projection lens may includes the mechanically engagement of additional attachment lenses (e.g., higher lumen lens, magnification lens) thereon to enhance the projection distance, clarity and/or color quality of the projection.

The video and/or still cameras may likewise include the capability for coupling (i.e., mechanical) engagement of zoom and/or telephoto lenses well known in the art of photography. The portable computer may be configured to digitize images captured by the video and still cameras for manipulation (i.e., editing) prior to projection by the projector assembly or prior to transmission to the remote server. The portable computer may further be configured to allow real-time transmission of such captured images such as to a news broadcast network or real-time reporting such as in live feed coverage.

Optionally, the portable computer of the projector system may include a monitor portion having display panels on both sides wherein a display monitor is disposed on the inner side of the monitor portion and a tablet monitor is disposed on an outer side of the monitor portion. The combination of display monitor and tablet monitor on both sides of the monitor portion order for allow simultaneous display of images. In this manner, the operator of the projector system and/or portable computer may view or edit images prior to or simultaneous with display of the same images on the tablet monitor. The tablet monitor may be viewed by audience members and may further include outwardly extending cover portions that serve dual purposes of protecting the tablet monitor and providing additional area upon which an audience may view images of a presentation.

Advantageously, the combination of the projector system with video and still cameras and the portable computer with dual display panels (i.e., display monitor on inner side, tablet monitor on outer side) simplifies assembly of images with other content such as text and audio for wide-ranging applications. For example, it is contemplated that a film-maker can draft and edit a script for a motion picture enabling the assembly of the storyline in frames using images captured by the still camera. Following the securing of funding, the film-maker may then shoot the motion picture using the video camera included with the projector system on location. After editing the footage, the portable computer may be used to score music and sound effects as well as add special effects.

Due to the unique dual-screen arrangement of the portable computer with the projector system in combination with at least one additional keyboard portion, collaborators may edit the motion picture in real-time using the display monitor on the inner side of the monitor portion of the portable computer and using the tablet monitor on the outer side. Multiple keyboard portions wirelessly connectable to the portable computer allow for editing of the motion picture by multiple collaborators. When finalized, the motion picture can be submitted to studio executives wherein the finished version of the motion picture can be viewed on the tablet monitor with outwardly sliding cover portions for extending the width of the viewable screen such as for wide format viewing. As such, the combination of the projector system with the video and still cameras and the portable computer allows for initial filming of full length feature films.

### BRIEF DESCRIPTION OF THE DRAWINGS

Other objects and advantages of the present invention will become apparent and better understood by reference to the following detailed description considered in connection with the drawings in which like numbers refer to like parts throughout and wherein:

FIG. 1 illustrates an environment in which a projector system of the present invention may be used in conjunction with a portable computer which is further illustrated as being in communication with a remote server such as via satellite communications;

FIG. 2 is a perspective view of a projector assembly adaptive to be swivelably connected to a portable computer such as a laptop at a data port thereof;

FIG. 3 is a view of the projector assembly including a projector lamp connected to a housing via a swivel mount and optionally having at least one of a still camera and a video camera swivelably mounted to the housing;

FIG. 4 is a perspective view of a portable computer having a monitor portion outwardly pivoted to a keyboard portion wherein the monitor portion has opposing inner and outer sides and including respective ones of a display monitor and a tablet monitor for simultaneous viewing of images;

FIG. 5a is a perspective view of the portable computer further including a cover assembly disposed on the monitor portion wherein the cover assembly comprises a pair of cover portions hingedly connected to the monitor portion and which may also be configured as additional areas to view images; and

FIG. 5b is a perspective view wherein the cover assembly is comprised of the pair of cover portions connected to the monitor portion via sliding mechanisms and further illustrating a still camera and/or video camera swivelably mounted to the keyboard portion of the portable computer.

### DETAILED DESCRIPTION

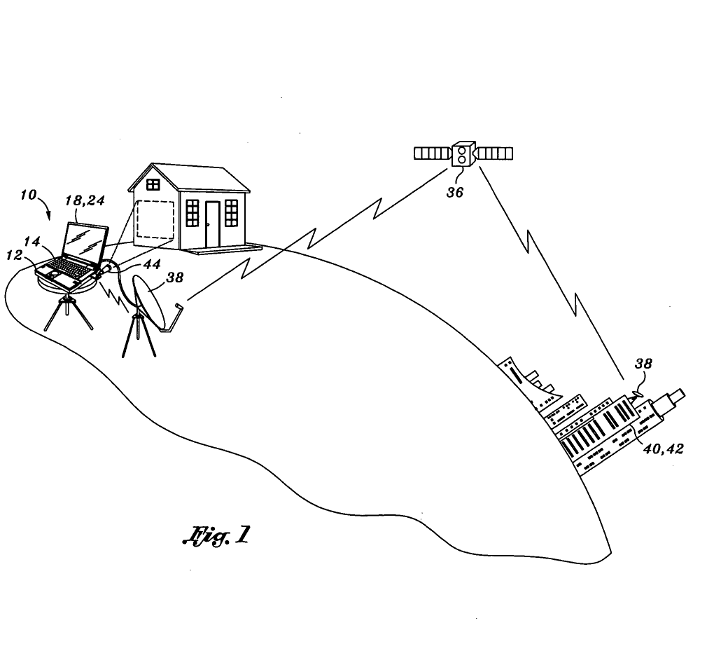

FIG. 1 illustrates an environment in which a projector system 10 of the present invention may be advantageously used such as at a remote location where infrastructure (i.e., electrical power, internet access) for operating electronic devices is not readily available. In this regard, the projector system 10 of the present invention is specifically adapted for use with a portable computer 12 in which at least one of the projector system 10 and portable computer 12 is capable of accessing images from a remote server 40 or remote computer such as via a communications satellite 36 system or any other suitable wireless communication system.

The remote server 40 may be located a relatively large distance (e.g., overseas) from the location wherein the projector system 10 is to be used. For example, as shown in FIG. 1, the remote server 40 may be located in an urban environment such as in a city in North America and may be accessible through an internet network 42 via the communications satellite 36. The communications satellite 36 is preferably capable of transmitting and receiving data from a receiving/transmitting station. The receiving/transmitting station may, in turn, be connected to the remote server 40 via the internet network 42. However, the remote server 40 may be directly accessible by the communications satellite 36.

Users of the projector system 10 of the present invention may include missionaries, educators, humanitarian organizations, news agencies as well as contractors and military personnel. In this regard, the projector system 10 is uniquely adapted for transmitting and receiving information from a remote location and is not necessarily limited to data that may be accessible on a remote server 40 but may include data that is specifically transmitted by individual organizations or institutions to the remote location wherein the projector system 10 is in use. In addition, the projector system 10 is useable in distance learning, education, entertainment, for medical purposes such as in surgical consultations and for real-time new reporting as described in greater detail below.

Furthermore, the projector system 10 is adapted for use by business persons and is uniquely suited for facilitating communications from remote locations wherein images may be projected onto any surface for business purposes. Such images may also include slide presentations for business conferences, seminars, and meetings such as for global negotiations and to facilitate multi-national mergers and acquisitions. The presentation material may include, but is not limited to, still and moving images such as movies, photos and additionally may include audio capability that is separate from or is included with the visual presentation of images.

Optionally, the projector system 10 may be adapted for projecting static and/or dynamic (i.e., moving) images in three-dimensional (3D) holographic form to enhance the impact of the message being delivered. For example, if the presentation materials are educational in nature covering, for example, American history, the projector system may be configured to project a pre-recorded and/or preprogrammed dynamic 3D holographic image of former U.S. President John F. Kennedy delivering his 1961 Inaugural Address.

The technology for projecting such holographic images may be similar to that which is disclosed in the document entitled “DYNAMIC HOLOGRAPHIC 3-D IMAGE PROJECTION” by Michael L. Huebschman et al. and published in Vol. 11, No. 5 of Optics Express in Jan. 6, 2003, incorporated by reference in its entirety herein. The technology for such holographic projection as incorporated into the projector system may also be similar to that which is disclosed in European Published Patent Application No. EP1467263 and entitled “MOVING IMAGE HOLOGRAPHY REPRODUCING DEVICE AND COLOR MOVING IMAGE HOLOGRAPHY REPRODUCING DEVICE” filed by Tomoyoshi Ito on Jan. 15, 2004, also incorporated by reference in its entirety herein.

The present invention is also configured for teleconferencing and/or video conferencing due to the optional inclusion of at least one of a still camera 54 and video camera 52 in combination with the projector system 10. In this regard, the still camera 54 and/or video camera 52 may be adapted to capture images of participants in the video conference at the remote location. The still camera 54 and/or video camera 52 operate as an interactive tool for real-time audio and/or video communication between participants in a manner as will be described in greater detail below.

The projector system 10 further includes the capability to project images of video conference participants at all sites for display of such images onto any surface. For example, as illustrated in FIG. 1, images may be projected or displayed onto the side of a house. Due to the compact size of the projector assembly 44 and its ability to swivel to any location and focus either manually or automatically, the projector system 10 reduces the amount of equipment that must be carried to the remote location and simplifies connectivity due to its self-contained power source and optional wireless connectively. In this regard, it is contemplated that the projector lamp 46 may be powered by the portable computer 10 and/or by a separate power source integrated into the projector assembly 44.

Referring to FIG. 1 in more detail, the projector system 10 is adapted for use with the portable computer 12 which is illustrated in a laptop configuration. The projector system 10 comprises at least one projector assembly 44 which is configured to be integrated with or detachability connectable to the portable computer 12 (i.e., laptop) such as at a suitable data port 16 of the portable computer 12. As shown in FIG. 1, the projector assembly 44 includes at least one projector lamp 46 which is adapted for projecting images. The projector lamp 46 may include the capability for removably mounting of additional lenses to enhance the projection distance, clarity and/or color quality of the images. Toward this end, lenses such as a higher lumen lens (i.e., higher intensity or brightness), a magnification lens or other lenses that may be removably secured to the projector lamp 46 to enhance the image to be projected. Although other means are contemplated, one such embodiment for engagement of such lenses may be by a twist-lock feature commonly used in attaching telephoto lenses to cameras in a manner well known in the art.

As was earlier mentioned, the projector assembly 44 is specifically adapted to wirelessly communicate with the remote server 40 in order to access images which may be contained on the remote server 40. However, it should be noted that images may be accessible from any suitable electronic device such as another portable computer 12 or from a desktop computer or a network of computers. The projector lamp 46 is shown configured in a cylindrical or slightly conical configuration and is uniquely adapted to be swivelably mounted to the portable computer 12 and is preferably of a compact size and is adapted to project images at any angle relative to the portable computer 12.

The portable computer 12 and/or projector assembly 44 may include appropriate electronic componentry to facilitate wireless communication via the communications available. As shown in FIG. 1, the portable computer 12 and/or projector assembly 44 may be wirelessly or hardwired connected to a portable satellite dish 38 which, in turn, is adapted to transmit and receive data to and from the communications satellite 36.

Referring to FIG. 2, shown is the projector system 10 in conjunction with the portable computer 12 illustrating the projector assembly 44 swivelably mounted thereto. In this regard, the projector assembly 44 may further include a swivel mount 50 which is configured to allow for free rotation of the projector lamp 46 relative to the portable computer 12 in the manner as was previously described. As can be seen, the projector assembly 44 may be connected to a housing 48 via the swivel mount 50.

The housing 48 may be specifically adapted to engage specific portions of the portable computer 12 such as the side of the laptop shown in the figures. The housing 48 is configured to physically support the weight of the projector assembly 44 such as by direct contact of the housing 48 against the side of the laptop or via engagement of mating mechanical features on each mating component. Furthermore, the housing 48 is specifically adapted to contain the necessary electronic circuitry to allow for the exchange of images between the portable computer 12 and the projector assembly 44. Power for the projector assembly may be provided by the portable computer.

As was earlier mentioned, the projector lamp 46 is specifically adapted for projecting images which may be contained within the portable computer 12 or which may be downloaded from an appropriate memory device such as a diskette, CD-Rom, or flash memory drive to the portable computer 12 prior to connecting of the projector assembly 44 thereto. Additionally, data to be projected by the projector assembly 44 may be wirelessly transmitted in real-time (i.e., during projection of the image by the projector lamp 46) and such images may be transmitted to at least one of the portable computer 12 and/or projector assembly 44 such as via any appropriate hardwired and/or wireless (i.e., communications satellite 36) means.

Electronic connectivity between the projector assembly 44 and the portable computer 12 may be facilitated by means of plugging the projector assembly 44 into a data port 16 of the portable computer 12. Such data port 16 can also be adapted to provide power to the projector assembly 44. However, as was earlier mentioned, the projector assembly 44 may be provided with its own power source such via batteries and/or appropriate hardware and software for powering by alternative energy means such as solar energy panels that may be carried with the projector system 10. Control of the projector system 10 may be provided by manipulation of keyboard keys (i.e., alpha-numeric keys) on the keyboard portion 14 which is common to most laptops.

Optionally, as shown in FIG. 4, at least one additional keyboard portion 14 may be included and may be electrically connectable to the portable computer 12 to allow for manipulation of images to be displayed on the monitor portion 18. The additional keyboard portion 14 is preferably adapted to allow for manipulating or editing of images or content simultaneous with editing by another user such as a user of the portable computer 12. Such editing may include the making of notations and adding content to the images and may be particularly useful for particular purposes such as during negotiations wherein the terms of a document are edited by the parties. The portable computer 12 may include the capability for printing out a hardcopy of the document for review by the parties or for delivery to a client. The additional keyboard portion(s) 14 may also facilitate use of the projector system 10 for educational purposes as well as allowing for electronic gaming by multiple participants as was mentioned above.

In addition, the projector assembly 44 and/or portable computer 12 may be specifically adapted for real-time communication with a remote control device 34 such as that shown in FIG. 2. In this regard, the remote control device 34 is configured for advancing slides during a slide presentation as projected by the projector assembly 44. The remote control device 34 may be hardwired and/or wirelessly connected to the portable computer 12 and/or projector assembly 44.

Optionally, the portable computer 12 may include a trackball 56 integrated into the keyboard portion 14 to facilitate manipulation of presentation slides and/or allow for directional control of the projector lamp 46. Redirecting of the projector lamp 46 to a new orientation may be facilitated by the user via the trackball 56 by manually rotating or spinning the trackball 56. However, it is contemplated that the trackball 56 may also be provided purely for regulation of the presentation materials such as when advancing slides, pausing during a video presentation, or performing any other desired presentation operation. For control of the presentation by the remote control device 34, it is contemplated that any suitable wireless communication means may be utilized including, but not limited to, WiFi, BlueTooth, infrared, shortwave, ultrasound and microwave or any suitable transmission technology.

It is further embodiment integrating the projector lamp 46 with the video and/or still cameras 52, 54, the projector assembly 44 and/or video/still cameras 52, 54 may be removably connectable to the portable computer 12 at any suitable data port 16 such as a USB port commonly included with most personal computers and laptops. As can be seen in FIG. 2, the projector system 10 may be further adapted to be swivelably mounted to a monitor portion 18 of the portable computer 12 such as to the display panel shown in FIG. 2. In this regard, the projector lamp 46 may be connected to a housing 48 of the projector assembly 44 by means of a swivel mount 50 which allows for free rotation and pivoting of the projector lamp 46. Electrical connectivity between the projector assembly 44 and portable computer 12 may be by means of any suitable hardwired or wired connection such as to one of the data ports 16 of the portable computer 12.

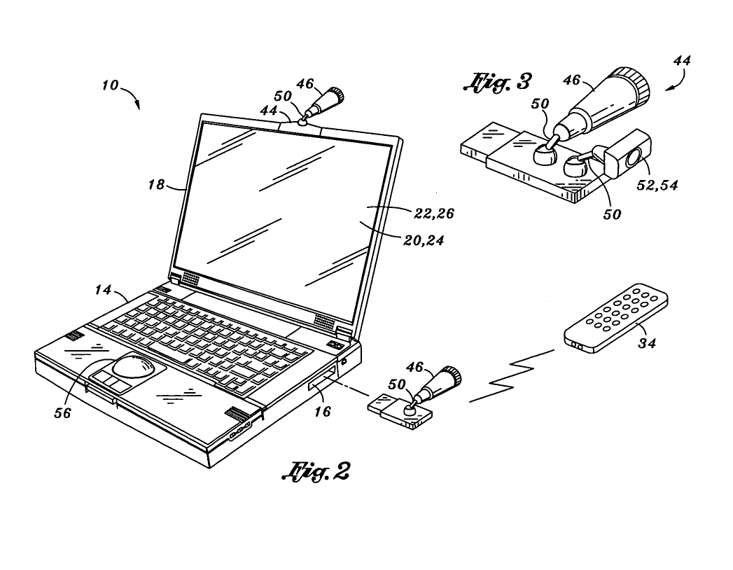

Referring now to FIG. 3, shown is an enlarged view of the projector assembly 44 illustrating the projector lamp 46 which is supported on the housing 48 by means of the swivel mount 50. The swivel mount 50 itself may be configured as a ball and socket type joint for the housing 48 and for the projector lamp 46. The projector lamp 46 may further include the capability for auto-focus as may be desirable during reorientation of the projector lamp 46. However, manual focus of the projector lamp 46 may be facilitated by means of a focus ring located on an extreme end of the projector lamp 46 and whereby rotation thereof facilitates focusing of images onto the chosen display surface.

As was mentioned above, the housing 48 itself may include structural features to facilitate physical support of the weight of the projector assembly 44 and to provide a means for engaging the housing 48 to the portable computer 12 to prevent inadvertent detachment such as may otherwise occur during manual reorientation or manual focusing of the projector lamp 46. The housing 48 may be provided with a suitable fitting complimentary to the chosen data port 16 to which the projector assembly 44 is to be connectable to. As was earlier mentioned, the housing 48 may contain appropriate componentry in order to facilitate communication between the portable computer 12 and the projector assembly 44. In addition, the housing 48 may optionally contain appropriate RF transmission (i.e., wireless transmission) componentry to facilitate communication to the remote server 40 such as via the communications satellite 36 with the assistance of the portable satellite dish 38 as shown in FIG. 1.

The projector system 10 may further include the video camera 52 and/or the still camera 54 which are adapted to be placed in communication with the portable computer 12 and may optionally be physically connected thereto or integrated therewith. As can be seen in FIG. 3 in an exemplary configuration, the still camera 54 and/or video camera 52 may be swivelably mounted to the housing 48 of the projector assembly 44. However, it should be noted that the still camera 54 and/or video camera 52 may be directly mounted as separate components to the portable computer 12. In this regard, the video and/or still camera 52, 54 may preferably be mounted on one side of the portable computer 12 while the projector lamp may be mounted on an opposing side. Such opposed mounted may avoid interference between the high-intensity projection of images by the projector lamp 46 and the contemporaneous capturing of moving and/or still images by the video and still cameras 52, 54 as may otherwise occur if co-located with the projector lamp 46.

The video and still cameras 52, 54 may be electrically connected at a data port 16 on one side of the portable computer 12 while the projector assembly 44 may be electrically connected to another data port 16. If integrated into the portable computer 12, the video camera 52 and/or still camera 54 preferably include swivel mount 50 which detachably connects the video and/or still camera 52, 54 to the portable computer 12. In another embodiment, the projector lamp 46 may be integrated into the portable computer 12 with the video and/or still cameras 52, 54. In this arrangement, the projector lamp 46 and cameras 52, 54 are preferably separately mountable on swivelable and/or rotatable supports such that each may be oriented in different directions as would be advantageous for certain applications such as real-time new reporting as described in greater detail below.

Although FIG. 3 illustrates the still camera 54 and/or video camera 52 being mounted to the housing 48 of the projector assembly 44, FIG. 4 illustrates an alternative arrangement wherein the still camera 54 and/or video camera 52 are separately connected to the portable computer 12 such as on a back side of the keyboard portion 14. As can be seen, the video camera 52 and still camera 54 in FIG. 4 are adapted to be swivelable within a predetermined field of view to allow capture of still and/or moving images as may be required during video conferencing or news reporting. The portable computer 12 may include the capability for digitalizing images captured by the video camera 52 and/or still camera 54 for wireless transmission such as via the communications satellite 36 illustrated in FIG. 1 to the remote server 40 or to a news network such as via the internet.

In this regard, the combination of the video camera 52 and/or still camera 54 with the portable computer 12 may facilitate distance learning wherein educational materials available from the internet via the communications satellite 36 may be transmitted back to the remote location of the portable computer 12 for viewing. In such a scenario, the video camera 52 and/or still camera 54 may be oriented to capture images of the participants at the remote locations such that an educator located in a distant location can view students at the remote location to gauge their progress. Likewise, the projector assembly 44 may be adapted to receive images of the educator which are transmitted thereto via the communications satellite 36 or other suitable communication means to the remote location for projection onto a suitable surface with optional simultaneous projection of educational materials.

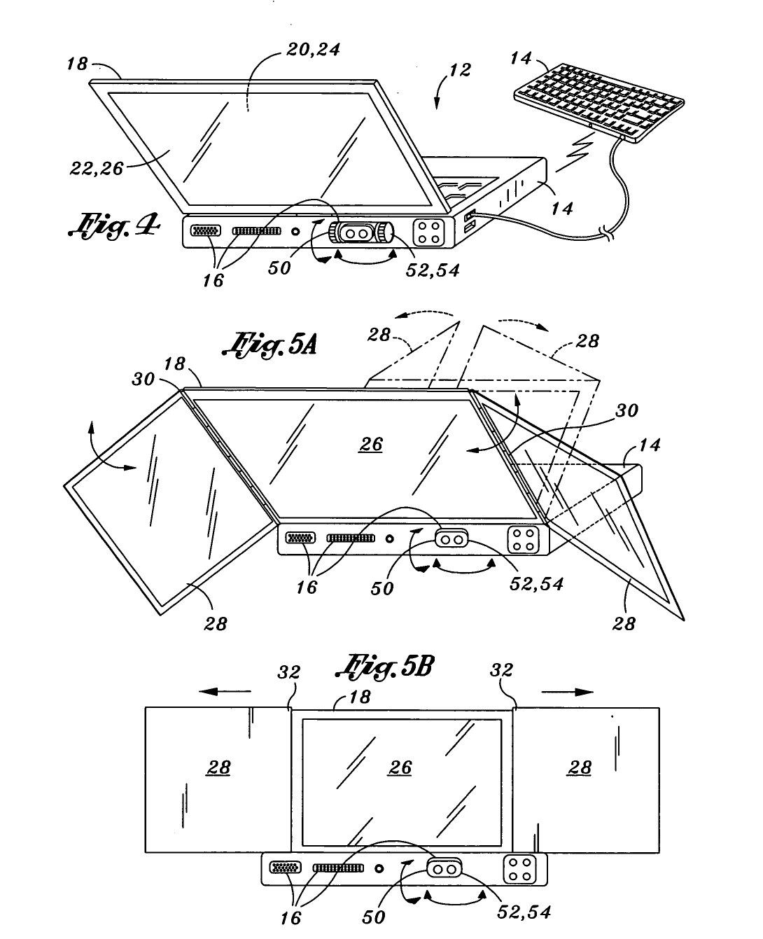

Referring to FIGS. 4 and 5a to 5b, shown is the projector system 10 wherein the monitor portion 18 of the portable computer 12 is outwardly pivotable to the keyboard portion 14 in a configuration common to portable computers 12 as known in the art. In this regard, the monitor portion 18 is typically hingedly connected to the keyboard portion 14. The monitor portion 18 typically has opposing inner and outer sides 20, 22 where the inner side 20 of the laptop is typically configured to display images for viewing by the operator of the portable computer 12. In this regard, the monitor portion 18 may be configured as a liquid crystal display (LCD), an active matrix TFT (i.e., thin-film transistor) or any other suitable display technology.

Optionally, the monitor portion 18 has opposing inner and outer sides 20, 22 as shown in FIGS. 4 and 5 to 5a and wherein a display monitor 24 is disposed on the inner side 20 but further including a tablet monitor 26 disposed on the outer side 22 such that the display monitor 24 and tablet monitor 26 allow for dual or simultaneous display of images. With this arrangement, the operator of the keyboard portion 14 can view the same images that are being viewed by an audience on the tablet monitor 26. Such a dual configuration of the monitor portion 18 allows for real-time manipulation of presentation materials prior to display on the tablet monitor 26. The presentation materials may be downloaded into the portable computer 12, from a memory device such as from a flash memory stick, or wirelessly transmitted such as from the remote server 40 to the remote location.

The outer side 22 of the monitor portion 18 may further include a cover assembly to protect the tablet monitor 26 from the elements and from damage. The cover assembly is preferably configured to be removable to reveal the tablet monitor 26 during use of the projector system 10. As shown in FIG. 5a, the cover assembly may be comprised by a pair of cover portions 28 which may be hingedly connected to the display monitor 24 by a pair of hinge mechanisms 30 disposed on opposing sides of the monitor portion 18. As was earlier mentioned, the cover portions 28 shown in FIG. 5a may include a display monitor 24 on the inner side 20s thereof and which are capable of displaying a continuous image across all three screens (i.e., the tablet monitor 26 in the center and the cover portions 28 on each side).

Alternatively, the cover portions 28 may be slideably connected to the monitor portion 18 by means of a pair of sliding mechanisms 32 in a manner shown in FIG. 5b. After delatching the cover portions 28 from one another, the cover portions 28 may be outwardly slid in order to reveal the display screen of the tablet monitor 26. The hinged connection of the cover portions 28 as shown in FIG. 5a may be used to provide shading in order to enhance visibility of images on the tablet monitor 24 when used during the day or outdoors wherein light levels are relatively high.

In order to facilitate video conferencing, distance learning or news reporting applications, the projector system 10 shown in FIGS. 5a and 5b may further include the still camera 54 and/or video camera 52 which may be integrated into the computer or may be detachably coupled thereto and are preferably swivelably mountable. Operation of the video camera 52 and/or still camera 54 is similar to that described above wherein the still camera 54 and/or video camera 52 may be oriented in the desired direction in order to capture images. In this regard, the still camera 54 and/or video camera 52 may facilitate field reporting of events and images in remote locations by single person for either real-time transmission back to the base station such as the main news network or for storage within the portable computer 12 for editing and/or manipulation prior to transmission.

Such a configuration may eliminate the need for a separate camera during news reporting such that images captured by the still and/or video camera 54, 52 can be uploaded in real-time to the main news network in distant city or country such as by using satellite, cellular or any other suitable wireless communication link. In addition, the configuration shown in FIGS. 5a and 5b may facilitate simultaneous display of images captured by the still camera 54 and/or video camera 52 for display on the display monitor 24 and tablet monitor 26. The projector system 10 may facilitate projection of the images which may also be viewable on the display monitor 24 and/or tablet monitor 26.

Projection of such images may allow for a larger viewing audience. Image projection technology that may be incorporated into the projector assembly 44 can include CRT (i.e., red, green and blue cathode ray tubes), LCD, digital light processing (i.e., DLP) or any other suitable projection technology such as liquid crystal on silicon (LCOS) or DLP with CRT. As was mentioned above, additional lenses may be removably mounted to the projector lamp 46 to enhance the projection distance, clarity and/or color quality of the images. Connection between the portable computer 12 and projector assembly 44 may be by any suitable wired or wireless means as mentioned above. For example, wireless connection of the projector assembly 44 with the portable computer 12 can include cellular, BlueTooth™, infrared (IR), radio frequency (RF), WiFi (i.e., WLAN-wireless local area network-directly or through the internet), ultrasound or satellite.

Hardwire connection technology can include coaxial cable, fiber optic and Ethernet or any other suitable wired technology. Furthermore, the remote control device 34 may include a conventional remote control device 34 or another laptop, a personal digital assistant (i.e., PDA such as a PalmPilot™ or a Blackberry™), cellular telephone, digital camera, or control buttons integrated into an article of clothing such as a suit jacket. Each of these remote control devices 34 is preferably adapted for manipulating and advancing presentation materials displayed by the projector assembly 44 of the present invention.

In addition, it is contemplated that the projector assembly 44 may be adapted to be wirelessly or hardwired connected to the keyboard portion 14 which is provided without a monitor portion 18 as is more typical of portable computers 12. In this regard, the keyboard portion 14 may be wirelessly or hardwired connected to the projector assembly 44 to allow manipulation of the presentation parameters such as volume, brightness, focus, on/off sleep mode as well as manipulation of presentation materials such as advancing PowerPoint slides.

As was briefly mentioned above, the projector lamp 46 itself may preferably include a high luminescence lens for optimal projection of images onto any surface regardless of ambient light conditions. As was earlier mentioned, the projector assembly 44 is also preferably provided in a self-contained or self-powered version in order to avoid reliance upon external power sources which are typically unreliable and many times unavailable in undeveloped countries. The projector lamp 46 may further include an auto-focus capability and/or manual-focus capability by means of rotation of a lens focus ring as previously discussed. However, the projector assembly 44 may be adapted to receive power from the portable computer 12 or other device to which it is wirelessly or hardwire connected.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A projector system adapted for use with a portable computer, the projector system comprising:
a projector assembly configured to be detachably connectable to the portable computer at a data port thereof;
wherein:
the projector assembly including a projector lamp for projecting images onto a surface;
the projector assembly being adapted to wirelessly communicate with a remote server for accessing images therefrom for projection by the projector lamp.

2. The projector system of claim 1 wherein:
the portable computer further includes a display monitor;
the projector lamp being configured to be removably mountable on the display monitor.

3. The projector system of claim 1 wherein the projector assembly further includes a swivel mount configured to allow free rotation of the projector lamp relative to the portable computer.

4. The projector system of claim 1 wherein at least one of the projector assembly and portable computer is adapted for real-time communication with the remote server.

5. The projector system of claim 1 wherein at least one of the projector assembly and portable computer is in communication with the remote server through an internet network.

6. The projector system of claim 1 wherein at least one of the projector assembly and portable computer is in satellite communication with the remote server.

7. The projector system of claim 1 further comprising a remote control device configured to allow for control of the projector assembly.

8. The projector system of claim 7 wherein the remote control is adapted to communicate with the processor using at least one of the following transmission technologies: WiFi™, Bluetooth™, infrared, shortwave, ultrasound, microwave.

9. The projector system of claim 1 further comprising at least one of a video camera and a still camera in communication with the portable computer.

10. The projector system of claim 9 wherein the projector assembly further includes a swivel mount configured to swivelably couple the video and still cameras to the portable computer.

11. The projector system of claim 9 wherein:
the projector lamp and video and still cameras are integrated into the portable computer;
at least one of the projector lamp and video and still cameras being swivelably rotatably in relation to the portable computer.

12. A projector system comprising:
a portable computer having a monitor portion outwardly pivotable connected to a keyboard portion, the monitor portion having opposing inner and outer sides and including:
a display monitor being disposed on the inner side;
a tablet monitor being disposed on the outer side;
wherein:
the display monitor and tablet monitor are adapted to allow dual display of images thereon; and
a projector assembly configured to be detachably connectable to the portable computer, the projector assembly including:
a projector lamp configured to project images onto a surface;
wherein:
at least one of the projector assembly and portable computer is adapted to wirelessly communicate with a remote server for accessing images therefrom for projection by the projector lamp.

13. The projector system of claim 11 further including at least one keyboard portion in communication with the portable computer and being configured to edit images on the monitor portion simultaneous with editing of the images at the portable computer.

14. The projector system of claim 11 wherein the monitor portion further includes a cover assembly disposed on the outer side and removably covering the tablet monitor.

15. The projector system of claim 13 wherein the cover assembly is comprised of a pair of cover portions connected to the display monitor by at least one of a hinge mechanism and a sliding mechanism.

16. The projector system of claim 11 wherein the projector assembly is configured to be swivelably detachably mounted to at least one of the keyboard portion and the monitor portion.

17. The projector system of claim 11 wherein the projector assembly further includes a swivel mount configured to allow free rotation of the projector lamp relative to the portable computer.

18. The projector system of claim 11 wherein at least one of the projector assembly and portable computer is adapted for real-time communication with the remote server.

19. The projector system of claim 11 wherein at least one of the projector assembly and portable computer is in communication with the remote server through an internet network.

20. The projector system of claim 11 wherein at least one of the projector assembly and portable computer is in satellite communication with the remote server.

21. The projector system of claim 11 further comprising at least one of a video camera and a still camera in communication with the portable computer and being configured to capture images for simultaneous display on the display monitor and a tablet monitor.
